(19) United States
(12) Patent Application Publication
(10) Pub. No.: US 2012/0242315 A1
(43) Pub. Date: Sep. 27, 2012

(54) DC-DC Conversion Using Vibration

(75) Inventor: Subhash Rao P., Bangalore (IN)

(73) Assignee: Sasken Communication Technologies Ltd., Bangalore (IN)

(21) Appl. No.: 13/104,421

(22) Filed: May 10, 2011

(30) Foreign Application Priority Data
Mar. 23, 2011 (IN) 900/CHE/2011

(51) Int. Cl. G05F 3/10

(52) U.S. Cl. 323/304

(57) ABSTRACT

This invention relates to the field of vibration switches, and more particularly to vibration switches used for DC to DC switching conversion. DC to DC convertors use an electrical switch like MOSFET/transistor for conversion to switched DC. The MOSFET/transistor requires a power source for the switching action. A vibration switch comprising of metal or conductive polymer strip can be used for the switching action in a DC to DC convertor. The strip is bent by using a small weight attached to one end. When exposed to vibration beyond a certain threshold the metal strip oscillates and performs multiple switching operations by connecting to the contact terminal. The switched DC thus produced could be filtered to generate a DC output. This switch does not require power for operation. The vibration sensitivity and frequency of oscillations of the switch can be controlled using the hardness of the material used.

### FIELD OF INVENTION

This invention relates to the field of vibration switches, and more particularly to vibration switches used for DC to DC switching conversion.

### BACKGROUND OF INVENTION

Vibration switches have been long used in critical operations like in case of machinery. Vibration switch is a device that recognizes the amplitude of the vibration exposed to and provides a response when this amplitude exceeds a certain predetermined threshold value. An electrical contact closing and opening demonstrates the vibration switch response. Vibration switches do not require power and utilize the resistive force and natural physical phenomena leading to displacement of a spring as a means of switching.

Further there are spring mounted vibration switches, wherein the switches are pulled back into position by the inertial action of the spring. However, over time the spring may lose its elasticity, which may lead to degradation in performance of the switch.

DC to DC generators convert DC energy into switched DC in electrical circuit. Common DC to DC generators like buck convertor, boost convertor, inverter and fly back transformer use an electrical switch like MOSFET or other transistor for conversion to switched DC. The switched DC signal is then rectified using a diode and filter to get required levels. The MOSFET or other transistor requires a power source for the switching action. Even during idle time power is consumed. Vibration switches do not require power for the operation of the switch, but offer lower accuracy as compared to electrical switches.

### OBJECT OF INVENTION

The principal object of this invention is to provide vibration switch suitable for switching action for DC to DC conversion.

Another object of the invention is to provide a vibration switch converting sensed vibration into switching DC.

A further object of the invention is to provide a vibration switch for sensing a vehicle vibration.

Another objective is to avoid any spring usage for measuring the vibration.

### STATEMENT OF INVENTION

Accordingly the invention provides a vibration switch used in DC to switched DC conversion; the vibration switch comprising at least one means adapted for sensing vibration in surrounding environment; converting the vibration to switched DC; and filtering the switched DC to get a final DC output.

There is also provided a method of DC to switched DC generation using a vibration switch; the method comprising steps of sensing vibration in surrounding environment; converting the vibration to switching DC; and filtering the switched DC to get a final DC output.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a block diagram of an DC to DC convertor circuit with a vibration switch, according to embodiments as disclosed herein;

FIG. 2 illustrates an enclosed vibration switch, according to the embodiments as disclosed herein;

FIG. 3 illustrates a non-enclosed vibration switch, according to the embodiments as disclosed herein;

FIG. 4. illustrates the swing action of a vibration sensing strip, according to the embodiments as disclosed herein;

FIG. 5 illustrates a block diagram of a buck type DC to DC convertor, according to the embodiments as disclosed herein;

FIG. 6 illustrates the amplitude of vibration sensed using strips as switch, according to the embodiments as disclosed herein; and

FIG. 7 illustrates the converted DC output from the circuit at Vₒᵤₜ, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of the embodiments herein and to enable those of skill in the art to practice the embodiments herein. Accordingly, the examples should not be construed as limiting the scope of the embodiments herein.

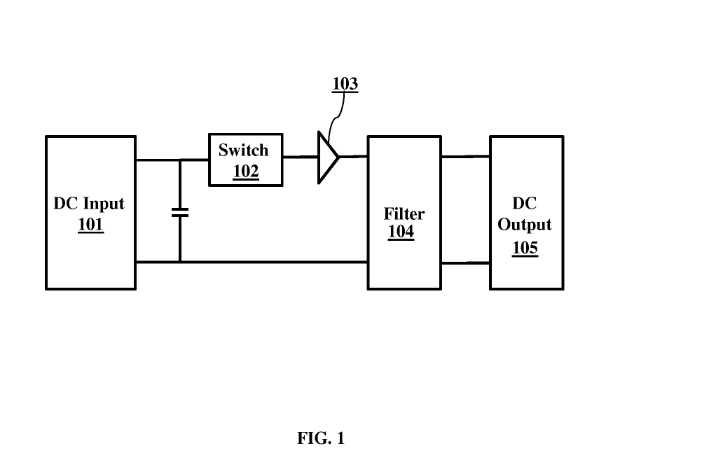

The embodiments herein achieve a DC to DC switching by sensing a vibration. Referring now to the drawings, and more particularly to FIGS. 1 through 7, where similar reference characters denote corresponding features consistently throughout the figures, there are shown preferred embodiments.

FIG. 1 illustrates a block diagram of a DC to DC generator circuit with a vibration switch, according to embodiments as disclosed herein. The DC-DC converter uses the switch for energy conversion from DC to switched DC. A DC input 101 gets converted by a vibration switch 102, to switched DC output 105. The source of vibration may be at least one from movements made by machinery during their operation. The vibrations may also be caused by the movement of vehicles or caused by the operation of the engines of vehicles. The vibrations may be caused by the movement of people such as people walking, jogging, running, and so on. The source of the vibrations may be movement of air or the flow of any fluid such as water. The source of the vibrations may also be caused by any intentional and/or non-intentional generation from a human such as respiration, circulation, pulse and so on. Filtering of the switched DC output is done using a filter 104 and diode 103 combination. A thin strip sensitive to vibration and contacts are used for switching. The strip may be of a suitable metal like Silver, Copper, Annealed copper, Gold, Aluminum and so on. The strip may also be of a suitable non metal like conductive polymers. The strip and contacts may be of similar material.

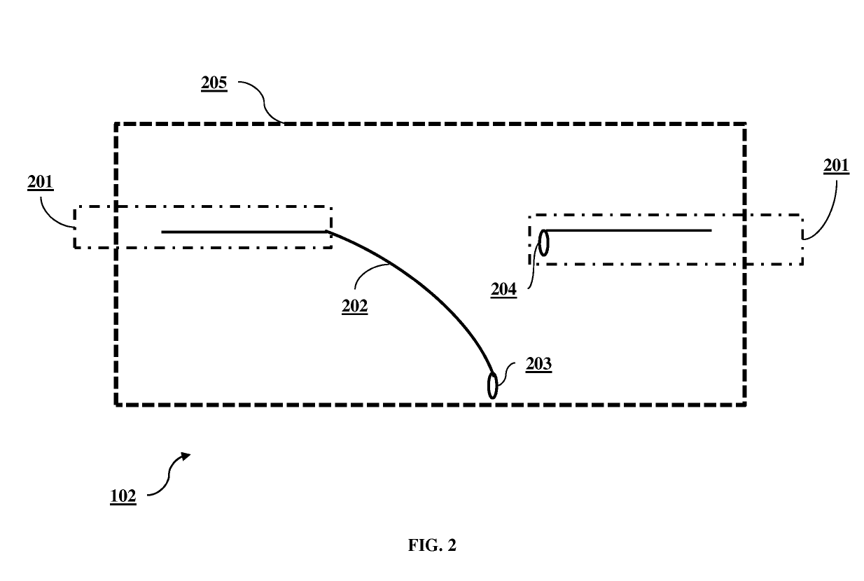

FIG. 2 illustrates a vibration switch, according to the embodiments as disclosed herein. The vibration switch 102 comprises of a strip 202 with a small weight 203 attached to its end. The strip 202 can be made sufficiently long so that it tends to bend due to natural gravitation force. When vibration is sensed by the strip, it oscillates towards 204 and back till it regains its original position. The addition of the weight allows for stronger vibration sensing. The contact terminals 201 of the vibration switch 102 can be any conductive surface. In order to avoid corrosion, the contact terminal may be coated with gold coated copper tips 204. Gold may be used as it is a good conductor and has very less contact resistance. The vibration switch 102 may be enclosed in a chamber 205 to prevent exposure to outside environment. For example, when the vibration switch 102 is used to provide lightings in tunnels or on streets based on vibrations produced by vehicular movements, the vibration switch 102 requires protection from forces of nature. The vibration switch 102 may be installed at certain point along the road. When a vibration is sensed from a vehicle, the strip 202 swings and connects to the contact 204 completing a switching action. Appropriately dimensioned strip will provide the required deflection from the centerline, which will serve as the pre-defined threshold of vibration to close the switch. From strength of material, bending of a beam fixed at one end is given by

d=4*F*1³/Y*a*b³

where F is force applied in N, 1 is length of beam in m, a is width in m, b is thickness in m, Y is young's modulus
In an example herein, assuming all parameters remains same then, bending formed due to Young's modulus value given by

| | Young's | (F - 0.25N, l - 0.01, |
|---|---|---|
| | modulus | a - 0.003, b - 0.001) |
| Material | KN/m² | b m |
| Steel | 200 | 1.66 |
| Aluminium | 69 | 4.83 |
| Gold | 79 | 4.21 |
| Silver | 89 | 3.74 |
| Copper | 117 | 2.84 |
| Carbon fiber | 181 | 1.84 |
| Silicon | 185 | 1.80 |

Vibration which creates force greater than that applied to bend the beam will generate the movement of vibrating element. Hence random vibrations which do not cross the threshold of vibration will not be sufficient to allow the strip to make contact with 204. Such vibrations are ignored and the switch remains open.

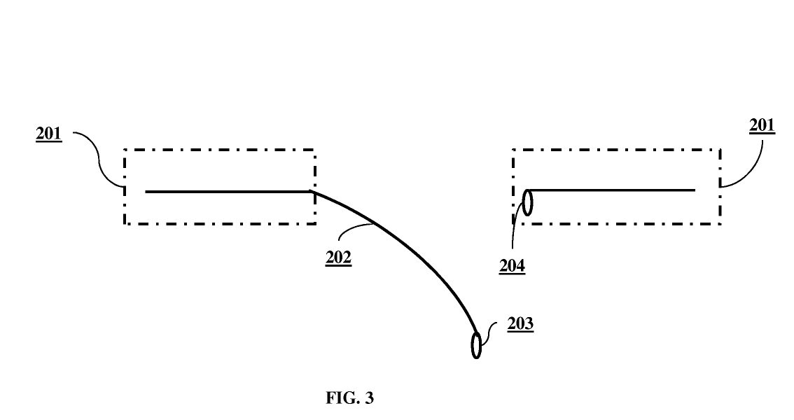

FIG. 3 illustrates a vibration switch, according to the embodiments as disclosed herein. The vibration switch 102 comprises of a strip 202 with a small weight 203 attached to its end. The strip 202 can be made sufficiently long so that it tends to bend due to natural gravitation force. When vibration is sensed by the strip it oscillates towards 204 and back till it regains its original position. The addition of the weight allows for stronger vibration sensing. The contact terminals 201 of the vibration switch 102 can be any conductive surface. In order to avoid corrosion, the contact terminal may be coated with gold coated copper tips 204. Gold may be used as it is a good conductor and has very less contact resistance. The strip is required to sense a pre-defined threshold of vibration to close the switch. Hence random vibrations which do not cross the threshold of vibration will not be sufficient to allow the strip to make contact with 204. Such vibrations are ignored and the switch remains open. The vibration switch used in this case does not require a chamber or an enclosure. This vibration switch may be used in situations where random vibrations are minimal.

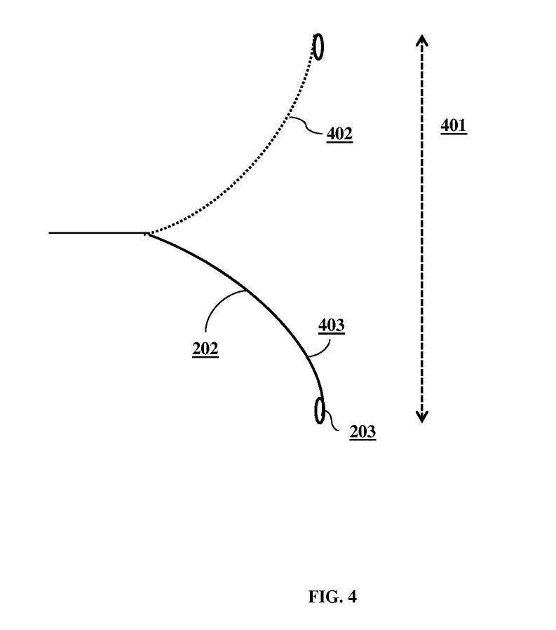

FIG. 4 illustrates the swing action of vibration sensing strip, according to the embodiments as disclosed herein. The strip 202 is made sufficiently long so that it tends to bend due to natural gravitation force. A small weight can be attached to the end of the strip for bending the strip more. When vibration is sensed by the strip it oscillates back and forth and regains its original position. The addition of the weight also allows for stronger vibration sensing. The range of movement of the strip 202 is indicated by 401. The position 403 indicates the position of the strip 102 when not exposed to vibration. When exposed to vibration exceeding a certain pre-defined threshold oscillations are produced which allow the strip to move to position 402. In case where a contact terminal is present in position 402; the metal can attach itself to the contact terminal and conclude a switching action. The swing action of the strip can be changed by using materials with different hardness. The hardness of the material is different for different types of materials. For example a light material can be used for sensing low intensity vibration. In case only a certain frequency of vibration is desired, hardness of the material becomes a deciding factor.

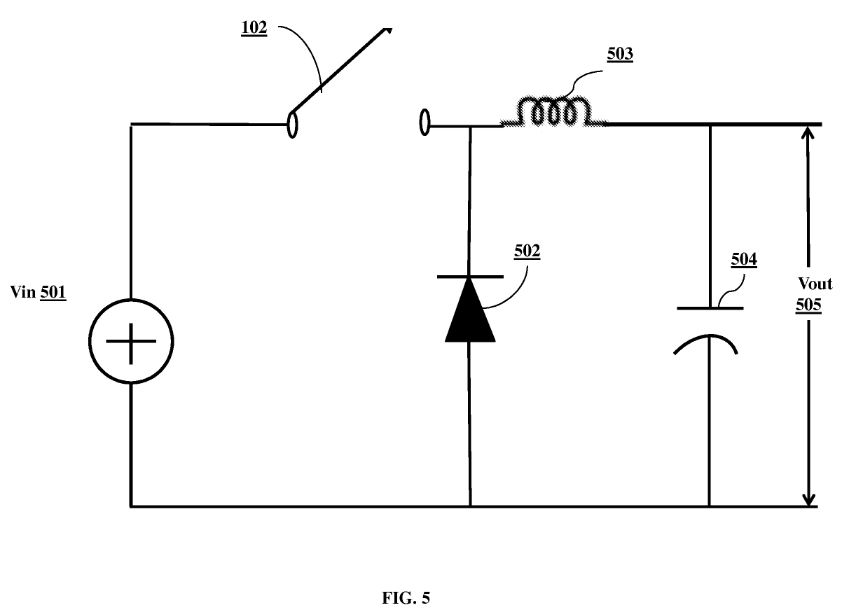

FIG. 5 illustrates a block diagram of a buck type DC to DC convertor, according to the embodiments as disclosed herein. A buck type DC to DC convertor consists of a battery source Vᵢₙ 501, a vibration switch 102, a diode 502, an inductor 503 and a capacitor 504. On sensing a vibration, the strip 202 of the vibration switch 102 produces oscillations causing the strip to swing and close the switch. The vibrations close and open the switch and the DC Vᵢₙ gets converted to switched DC using the diode 502.

The inductor 503 and capacitor 504 act as a filter and produce the Vₒᵤₜ 505. The Vₒᵤₜ 505 may be used to light an LED or a street light or a tunnel light.

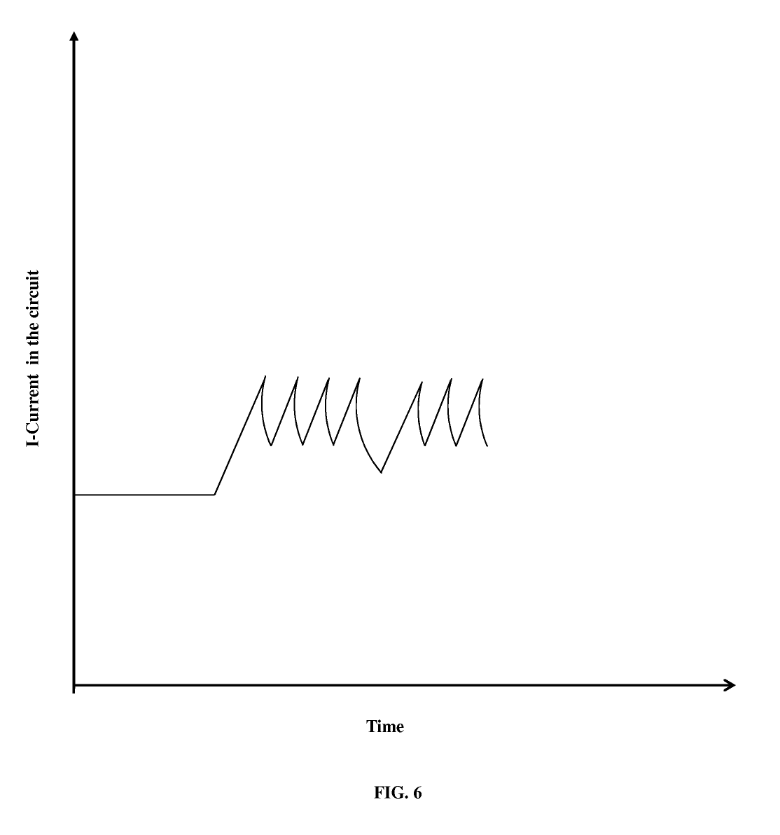

FIG. 6 illustrates the amplitude of vibration sensed using conductor strips as switch, according to the embodiments as disclosed herein. The DC to DC convertor used here is the buck type one described in FIG. 5. On sensing a vibration, the switch closes and the current produced by the circuit is plotted against time.

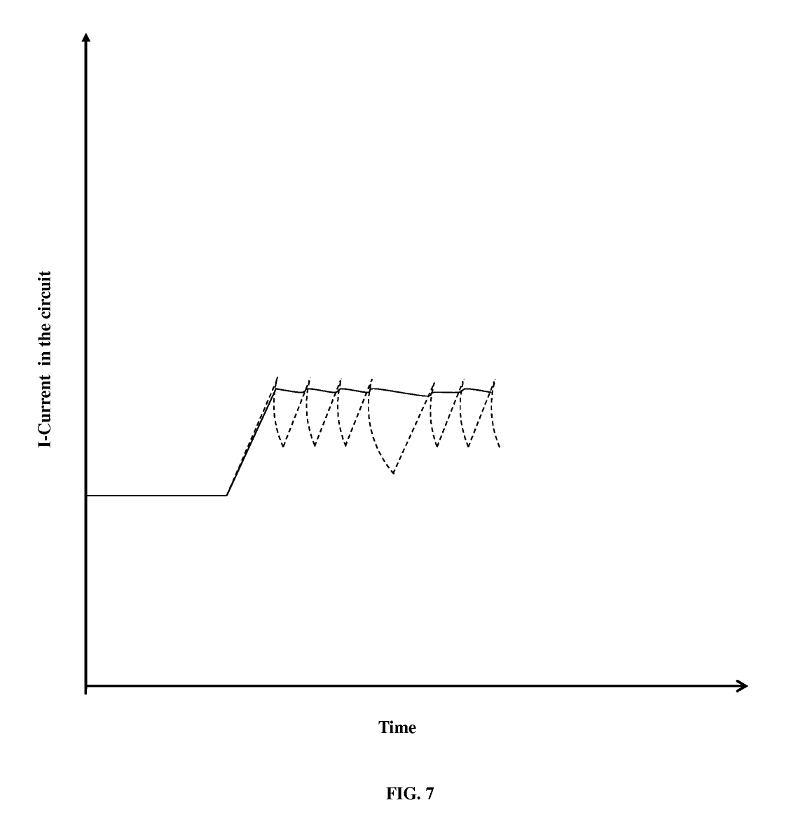

FIG. 7 illustrates the filtered DC available at Vₒᵤₜ, according to embodiments as disclosed herein.

Embodiments disclosed herein avoid use of a switcher circuit and transistor/MOSFET hereby eliminating the need for an external source of power.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A vibration switch used in DC to switched DC conversion; the vibration switch comprising at least one means adapted for:
sensing vibration in surrounding environment;
converting said vibration to switched DC; and
filtering said switched DC to get a final DC output.

2. The vibration switch of claim 1, wherein said vibration switch comprises of a strip for sensing said vibration.

3. The vibration switch of claim 2, wherein said strip is at least one of:
a metallic strip; or
a non-metallic strip.

4. The vibration switch of claim 2, wherein said strip has weights at the tip of said strip.

5. The vibration switch of claim 2, wherein said vibration switch is configured for converting said vibration to switched DC by enabling said strip to come in contact with contact terminals.

6. The vibration switch of claim 1, wherein said vibration switch comprises of a means for sensing vibrations above a pre-specified threshold.

7. The vibration switch of claim 1, wherein said vibration switch is configured for using a filter for filtering of said switched DC signal.

8. The vibration switch of claim 1, wherein said vibration switch is placed in an enclosure.

9. A method of DC to switched DC generation using a vibration switch; the method comprising the steps of:
sensing vibration in surrounding environment;
converting said vibration to switching DC; and
filtering said switched DC to get a final DC output.

10. The method of claim 9, wherein a strip is used for sensing of said vibration.

11. The method of claim 10, wherein said strip is at least one of:
a metallic strip; or
a non-metallic strip.

12. The method of claim 10, wherein said vibrations are converted to switched DC by connecting said strips to contact terminals.

13. The method of claim 9, wherein a filter is used for filtering said switched DC signal.
